(19) United States
(12) Patent Application Publication
(10) Pub. No.: US 2025/0355110 A1
(43) Pub. Date: Nov. 20, 2025

(54) Radar Detection in a Wireless Communication Device with Full-Duplex Below Noise Radar

(71) Applicant: Telefonaktiebolaget LM Ericsson (publ), Stockholm (SE)

(72) Inventors: Andres Reial, Höllviken (SE); Henrik Sjöland, Lund (SE); Ashkan Kalantari, Malmö (SE); Gang Zou, Lund (SE); Magnus Sandgren, Staffanstorp (SE)

(21) Appl. No.: 18/867,672

(22) PCT Filed: May 25, 2022
(86) PCT No.: PCT/EP2022/064287

§ 371 Date: Nov. 20, 2024

(51) Int. Cl. G01S 13/76; G01S 7/285; G01S 13/87

(52) U.S. Cl. CPC G01S 13/765; G01S 7/285; G01S 13/878

(57) ABSTRACT

A wireless communication device is configured to transmit radar signals at extremely low spectral density so that the receiver can be operated at the same time without saturating and thereby enabling full-duplex operation. To extend the capabilities of radar operation, a new correlator structure is proposed for detection of radar signals using discontinuous correlation of multiple short radar bursts that are temporally separated by communication signals. Discontinuous correlation as herein described enables long correlation times so that the detection range and target velocities can be increased, and target size can be reduced, compared to prior art.

### TECHNICAL FIELD

The present disclosure relates generally to wireless communication devices with radar capability and, more particularly, to a new correlator framework for discontinuous correlation of radar signals interspersed with communication signals.

### BACKGROUND

There is a need for radar functionality in wireless communication devices, such as mobile phones, and in wireless network equipment like radio dots and base-stations. In addition to communication, the equipment can then perform radar functions to sense the stationary and moving objects in the environment. The information obtained by sensing can be used by many different applications, such as safety and navigation. It is desirable to reuse the wireless communication modem to implement the radar functionality to reduce the design complexity as well as the number of components. It is also desirable to share the frequency resources between radar and wireless communication so that the radar functionality can be introduced with minimum degradation of the wireless communication quality and availability.

Published PCT application WO 2020/249314 to Agardh et al. titled “LOW POWER RADAR IN RADIO COMMUNICATION TERMINAL” discloses a wireless communication terminal that uses the same chipset for both wireless communications and radar probing. Agardh notes that radar probing can interfere with wireless communications and degrade the quality of communication signals. Agardh proposes reducing the radar transmit power to an extremely low level equivalent, for example, to a transmit OFF power level as defined in a wireless communication, such as the Fifth Generation(5G) standard developed by the Third Generation Partnership Project (3GPP), or to a spurious emission level set by authorities such as the Federal Communications Commission (FCC). The probability of interference with communication signals due to radar transmissions at such low transmit power levels or spectral densities is very low, and the radar can therefore be allowed to transmit at any time without coordination with the network. The low power radar signals can, on the other hand, be easily disturbed. Agardh notes that transmission of wireless communication signals may be inhibited in the device while it performs radar probing.

In Agardh, radar co-existence with normal communication operations is handled by deferring radar operations, or limiting radar operations to short bursts allowed by gaps between communication sessions. In the latter case, the low power of the radar signal and the bursty nature of the radar operation limits the radar range to a few tens of meters and the velocities of target to a few meters per second.

### SUMMARY

The present disclosure relates to wireless communication devices that use the same radio frequency (RF) transceiver for transmitting and receiving both communication signals and radar signals. The wireless communication device is configured to transmit radar signals at extremely low power spectral density (PSD) so that the receiver can be operated at the same time without saturating. To extend the capabilities of radar operation, a new correlator structure is proposed for detection of radar signals using discontinuous correlation of multiple short radar bursts that are interspersed with communication signals. Discontinuous correlation as herein described enables long correlation times so that the detection range can be increased, and target size can be reduced, compared to prior art.

A first aspect of the disclosure comprises methods implemented by a wireless communication device of detecting a low power radar signal transmitted in multiple parts interspersed between communication signals. In one embodiment, the method comprises receiving the radar signal in parts over multiple, discontinuous time periods. The method further comprises correlating each of two or more parts of the radar signal received in different ones of the discontinuous time periods with a reference signal to obtain partial correlation results. The method further comprises combining the partial correlation results for the two more discontinuous time periods to obtain a combined correlation result.

A second aspect of the disclosure comprises a wireless communication device with radar capability. In one embodiment, the wireless communication device is configured to receive the radar signal in parts over multiple, discontinuous time periods. The wireless communication device is further configured to correlate each of two or more parts of the radar signal received in different ones of the discontinuous time periods with a reference signal to obtain partial correlation results. The wireless communication device is further configured to combine the partial correlation results for the two more discontinuous time periods to obtain a combined correlation result.

A third aspect of the disclosure comprises a wireless communication device with radar capability including communication circuitry configured for below noise, full-duplex radar and processing circuitry The processing circuitry is configured to receive the radar signal in parts over multiple, discontinuous time periods. The processing circuitry is further configured to correlate each of two or more parts of the radar signal received in different ones of the discontinuous time periods with a reference signal to obtain partial correlation results. The processing circuitry is further configured to combine the partial correlation results for the two more discontinuous time periods to obtain a combined correlation result.

A fourth aspect of the disclosure comprises a computer program for a wireless communication device for detecting radar signals reflected from targets in the environment. The computer program comprises executable instructions that, when executed by processing circuitry in the wireless communication device, causes it to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

A sixth aspect of the disclosure comprises methods implemented by a wireless communication device of detecting a low power radar signal transmitted in multiple parts interspersed between communication sessions. In one embodiment, the method comprises determining a correlation configuration for detecting a reflected radar signal transmitted in parts during multiple discontinuous time periods interspersed between communication sessions. The correlation configuration includes a correlation length and a coherent block length for intermittent reception of different parts of the reflected radar signal in the discontinuous time periods. The method further comprises detecting the reflected radar signal received over multiple discontinuous time periods based on the correlation configuration.

A seventh aspect of the disclosure comprises a wireless communication device with radar capability. In one embodiment, the wireless communication device is configured to determine a correlation configuration for detecting a reflected radar signal transmitted in parts during multiple discontinuous time periods interspersed between communication sessions. The correlation configuration includes a correlation length and a coherent block length for intermittent reception of different parts of the reflected radar signal in the discontinuous time periods. The wireless communication device is further configured to detect the reflected radar signal received over multiple discontinuous time periods based on the correlation configuration.

An eighth aspect of the disclosure comprises a wireless communication device with radar capability including communication circuitry configured for below noise, full-duplex radar and processing circuitry. The processing circuitry is configured to determine a correlation configuration for detecting a reflected radar signal transmitted in parts during multiple discontinuous time periods interspersed between communication sessions. The correlation configuration includes a correlation length and a coherent block length for intermittent reception of different parts of the reflected radar signal in the discontinuous time periods. The processing circuitry is further configured to detect the reflected radar signal received over multiple discontinuous time periods based on the correlation configuration.

A ninth aspect of the disclosure comprises a computer program for a wireless communication device for detecting reflecting radar signals. The computer program comprises executable instructions that, when executed by processing circuitry in the wireless communication device, causes it to perform the method according to the sixth aspect.

A tenth aspect of the disclosure comprises a carrier containing a computer program according to the ninth aspect. The carrier is one of an electronic signal, optical signal, radio signal, or a non-transitory computer readable storage medium.

### BRIEF DESCRIPTION OF THE DRAWINGS

FIG. 1 illustrates the main functional components of a wireless communication device with radar capability.

FIG. 2 illustrates a first embodiment of a radio unit for a wireless communication device with radar capability.

FIG. 3 illustrates a first implementation of a radar detector for detecting reflections of the transmitted radar signal from remote objects.

FIG. 4 illustrates an exemplary correlator structure for multiple delay hypotheses.

FIG. 5 illustrates an exemplary correlator configured to perform discontinuous correlation.

FIGS. 6A and 6B are graphs showing loss of processing gain versus receive signal phase rotation.

FIG. 7 is a graph showing sensitivity to errors in the frequency response

FIG. 8 is a graph showing loss of processing gain versus receive signal phase rotation for an example.

FIG. 9 illustrates a method implemented by a wireless communication device of detecting a low power radar signal transmitted in multiple parts interspersed with communication signals.

FIG. 10 illustrates a method implemented by a wireless communication device of detecting a low power radar signal transmitted in parts.

FIG. 11A illustrates an exemplary wireless communication network including one or more wireless communication devices with radar capability.

FIG. 11B illustrates a user equipment (UE) with radar capability according to an embodiment.

FIG. 11C illustrates a base station with radar capability according to an embodiment.

FIG. 12A illustrates a first exemplary radar amplifier with a self-biased CMOS inverter.

FIG. 12B illustrates second exemplary radar amplifier also with a self-biased CMOS inverter.

FIG. 12C illustrates a radar amplifier configured as a tuned amplifier.

### DETAILED DESCRIPTION

The present disclosure relates to a wireless communication device 10 that uses the same radio frequency (RF) transceiver for transmitting and receiving both communication signals and radar signals. The techniques for implementing radar in the wireless communication device 10 is explained in the context of a wireless communication device configured to operate according to the 5th Generation (5G) standard developed by the Third Generation Partnership Project (3GPP). More generally, the wireless communication device 10 could operate according to any standard now known or later developed including without limitation Wideband Code Division Multiple Access (WCDMA), Long Term Evolution (LTE), Worldwide Interoperability for Microwave Access (WiMAX), Wireless Fidelity (WiFi), or 6th Generation (6G).

Frequency resources available for wireless communications are limited and very expensive. Introducing radar operation in a given frequency band will typically lower the quality and/or limit the resources available for communications. Coordination of frequency resources is also needed to avoid collision between communication and radar. A radar solution using minimal resources and requiring little or no coordination with the network would therefore be very attractive.

Most radar operations are based on mono-static radar, where the same device both receives and transmits. Operating a high-powered transmitter and a sensitive receiver at the same frequency in the same RF unit is challenging but can be solved by introducing physical isolation between antennas. This solution requires shielding metal and/or significant distances, which are expensive and impractical in a handheld unit. Furthermore, when using some antennas for transmission and others for reception, beamforming gain is reduced.

The separation between transmit and receive can also be realized in the time domain. In this case, all antennas transmit and all receive, but not at the same time. This approach requires fast antenna switches so that the switch can change its state during the short time period between the end of radar transmission and the return of the first reflection. This approach requires trade-offs in antenna switch design and very short radar signal duration that limits the sensing range.

Full-duplex solutions allowing transmission and reception at the same time from the same set of antennas exist. At high transmit power, however, there are many challenges in cancelling the strong transmit signal and its effect in the receiver. Cancellation must be performed in multiple domains; RF as well as digital baseband. The RF cancellation becomes costly and complicated in an array system due to multiple antenna channels. A full duplex system capable of radar operation without the need for RF cancellation would thus be highly attractive.

To alleviate some of these problems, embodiments of the present disclosure reduce the radar transmit power to an extremely low level equivalent, for example, to a transmit OFF power level as defined by the applicable wireless communication standard (e.g., 5G standard), or to a spurious emission level set by authorities such as the FCC. The power level may depend on channel bandwidth. As one example, the maximum transmit power level for radar signals could be set to −50 dBm transmit power. The threshold may also be given as power spectral density rather than a power level. The probability of interference with communication signals due to radar transmissions at such low levels or spectral densities is very low, and the radar can therefore be allowed to transmit at any time without coordination with the network. The low power radar signals can, on the other hand, be easily disturbed.

Low power radar reduces the required isolation and hence simplifies the design, and lends itself well to full duplex operation, i.e., to receive and transmit radar signals simultaneously. But the very low transmit powers required to realize these advantages limit the target range for radar detection to a few tens of meters and the velocities of the target to a few meters per second. Example applications for such low power radar include gesture tracking, indoor positioning, and drone altitude detection.

Detection of low power radar signals requires long observation times to obtain a sufficient signal-to-noise (SNR) for detection. The correlation gain becomes high when correlating for a long time, and this approach works fine for slow moving targets but is not well-suited for higher velocities. Additional gains may be obtained using repetition in time and/or frequency to increase the SNR of the reflected radar signals. This approach may require hundreds or thousands of repetitions to obtain meaningful gains. For moving objects, the repetitions cannot be distributed over too long a time and there may be limits on available bandwidths for large numbers of repetitions in the frequency domain.

Applications of radar have been used in the past in a dedicated and deliberate way to estimate precipitation, track a target in a military application, or capture data about the surroundings of a vehicle that is about to make a turn in an intersection, etc. But for applications that need to work over long durations and without any particular triggering events to indicate when radar is needed, a conventional radar operated in an always-on mode will use a lot of power and cause interference even if not used.

One aspect of the disclosure comprises techniques for implementing radar functionality in wireless communication devices 10. The wireless communication device 10 is configured to transmit radar signals at extremely low spectral density so that the receiver can be operated at the same time without saturating. The radar signal is amplified by a small radar amplifier operating while the regular power amplifier is turned off. The radar amplifier couples to the antenna signal through a large impedance to output a very low transmit power. Thus, full duplex operation is possible without the need for RF isolation.

The extremely low output power makes it safe to operate without coordination with the network, as causing a disturbance to communication would require an extreme proximity, i.e., close contact. If, however, a strong signal is detected, after the radar transmission signal has been subtracted, the radar operation can be interrupted or aborted to avoid even this small risk of causing interference.

The high bandwidth needed to reduce the spectral density may require equalization to achieve full radar performance. To achieve equalization, digital filters can be used in both receive signal path and transmit signal path.

To achieve sufficient range, beamforming is used together with a very long correlation time for detection of the radar signal, in which case the receiver can resolve backscattered or reflected radar signals far below the noise floor, while the bandwidth of the transmitted radar signal can be very high. The wide bandwidth enables the wireless communication device to maintain a low power spectral density while increasing output power, and also increase the depth resolution. The extremely low power spectral density even in the transmission beam direction makes the probability that communication will be disturbed very low. The high bandwidth calls for digital filters for both transmitted and received signals to equalize the radar frequency response characteristics of the radio unit.

Embodiments of the present disclosure relate to receiver processing, specifically correlation-based detection of reflected/back-scattered signals for radar or other sensing functionality. In full duplex operation, the radar transmitter transmits a signal with relatively long duration, e.g., 1 . . . 10 ms, while the radar receiver simultaneously processes its input signal to detect reflected copies of the transmitted signal. The radar signal does not pose an interference problem for received communications signals in normal scenarios, due to its low PSD. However, the full-duplex operation may pose certain challenges for received radar signal reception because the backscattered signal is typically attenuated by multiple 10s of dBs and requires considerable processing gain to sufficiently increase the detection SNR, even if the low noise amplifier (LNA) is not saturated.

To achieve sufficiently high processing gain, a long radar signal duration is necessary. In common scenarios and use cases, the cellular communications device that includes an integrated radar function has a dense communication schedule, e.g., transmission or reception every few ms or more frequently. This may be needed as the UE simultaneously shares radar sensing result information to a central entity when the most suitable band for communications is the band where radar is used. In conventional solutions, this means that the duration of the gap between the communication occasions defines the maximum length of a radar session, which in turn determines the achievable processing gain and the maximum path loss (and thereby the distance to objects to be sensed). In practice, this means that a conventional full duplex, low-power radar will not be able to detect objects beyond some minimum distance determined by the gap between communication sessions. Detection is even more challenging for UEs with short but frequent communication sessions.

This disclosure introduces a correlation approach where detection is not limited to a single radar session but multiple radar sessions may be coherently concatenated. If the transmitted signal and correlator's reference signal remain coherent across multiple radar sessions, coherent correlation may be extended over long aggregate intervals and high processing gain may be realized. One aspect of operation is ensuring that the phase references for the radar transmit signals, radar receive signals, and correlator reference signals are kept consistent (not allowed to drift with respect to one another) during the interruption due to communication sessions.

In contrast to the present disclosure, the objective of the traditional approach of sending radar signals in communication gaps is to avoid interference with cellular communication signals. In embodiments of the present disclosure, the criterion is whether communication signals cause excessive interference for own radar signal reception (in addition to rendering hardware unavailable for radar) and avoiding such interference. The approach can be viewed as opportunistic utilization of communication gaps or periods with low enough interference from communication

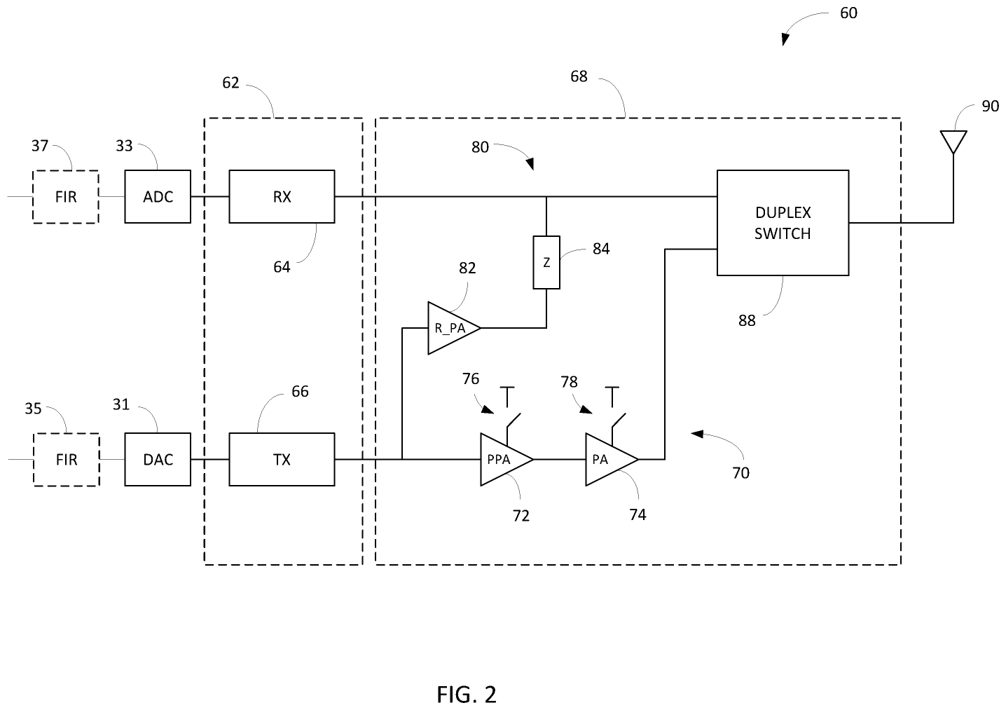

To demonstrate the feasibility of the concept, a numerical example will be provided. Assume a wireless communication device 10 with 100 antenna elements per panel, operating at 100 GHz center frequency with a 10 GHz bandwidth and a 14 dB total noise figure of the receiver. The receiver input noise floor in the 10 GHz bandwidth is equal to −60 dBm at each antenna. Further assume that the radar transmitter can provide −40 dBm per antenna, i.e., 20 dB above the receiver noise. Taking into account losses in the antenna switch (as shown in FIG. 2) of 3 dB, the radar transmitter will have to provide 3 dB more power for the signal on top of the 20 dB above the noise floor, i.e., −37 dBm per antenna. We assume that the receiver can handle a signal 23 dB above the noise floor without significant compression. It is then possible to subtract the transmit signal in the digital domain in the receiver.

The antenna gain is assumed to be 3 dB+10 log (100)=23 dB for both transmit and receive, where 100 is the number of antenna elements in the panel. In this case, the EIRP becomes −40 dBm+20 dB+23 dB=3 dBm, where the 20 dB is due to the 100 transmitters providing output power. The total radiated power (TRP) is −20 dBm. Assuming an integration time of up to 3 ms, we get a received radar signal noise of:

$$- 1 \; 74 dBm + NF - 10 log ( interogation time ) = - 174 + 14 + 25 = - 1 \; 35 dBm$$

The power of a reflected radar signal for on object at 10 m distance with a radar cross section of 0.01 m² can be calculated according to:

$${P}_{received} = {P}_{TX} + {G}_{TXant} + {G}_{RXant} + 10 log [ \frac{{λ}^{2} \cdot σ}{{( 4 π )}^{3} \cdot {R}^{4}} ] ]$$

where P_{TX} is the transmit power, G_{TXant}, is the transmitter antenna gain, G_{RXant}, is the receiver antenna gain, λ is the electromagnetic wavelength in air at the radar center frequency, σ is the radar cross section of the target to be detected, and R is the distance between the radar and the target. With these assumptions, the received power of the radar signal is:

$${P}_{received} = - 20 dBm + 23 dB + 23 dB + 10 log ( {0.003}^{2} \cdot 0.01 / ( {( 4 - 3.14 )}^{3} \cdot {10}^{4} ) ) = - 117 dBm \text{=>} SNR = - 117 - ( - 135 ) = 18 dB$$

It would thus be possible to detect an object with a radar cross section of 0.01 m² at 10 m distance with a correlation time of 3 ms, i.e., it would be possible to operate indoors with good possibility to detect also small objects with a high SNR.

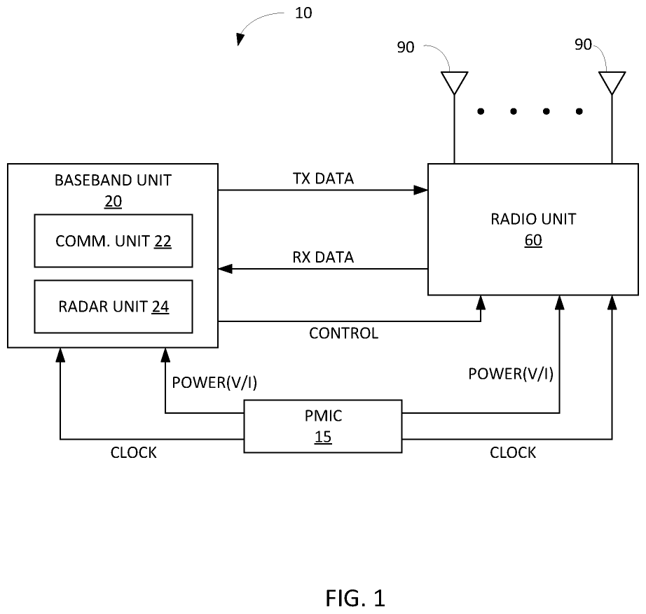

FIG. 1 illustrates the main functional components of a wireless communication device 10 in which the radar functionality is to be implemented. It is noted that the same reference numbers are used throughout the drawings to indicate similar elements or features. The wireless communication device 10 comprises a power management integrated circuit 15, baseband unit (BBU) 20, and radio unit (RU) 60 coupled to one or more antennas 90. The PMIC 15 provides power and clock signals to the BBU 20 and RU 60. The BBU 20 comprises the digital part of the wireless communication device 10 and the RU 60 comprises the radio part. The BBU 20 performs digital signal processing and controls the operation of the wireless communication device 10. The BBU 20 outputs controls signals to the RU 60 during operation. In embodiments of the present disclosure, the BBU 20 includes a communication unit 22 which is configured to transmit and receive communication signals and a radar unit 24 configured to transmit and receive radar signals. The RU 60 comprises RF circuitry for transmitting and receiving both communication signals and radar signals. The RU 90 couples to one or more antennas or antenna elements 90.

As used herein, the term “communication signals” refers to data signals and control signals transmitted and received by the wireless communication device 10 as part of normal operation according to applicable standards but does not include radar signals. In the context of 5G, the term “communication signals” contemplates all signals transmitted and received by the 5G wireless communication device 10. Communication signals may comprise, for example, data signals transmitted by the wireless communication device 10 on the Physical Downlink Control Channel (PDCCH), Physical Downlink Shared Channel (PDSCH) and Physical Broadcast Channel (PBCH), and all signals received by the wireless communication device 10 on the Physical Uplink Control Channel (UDCCH), Physical Uplink Shared Channel (PUSCH) and PBCH.

FIG. 2 illustrates an exemplary radio unit 60 for a wireless communication device 10. The RU 60 comprises a digital-to-analog converter (DAC) 31, an analog-to-digital converter (ADC) 33, a RF transceiver 62, and a front-end circuit 68. Some embodiments may include transmit and receive filters 35, 37 to compensate for the frequency response of the RU 60 as hereinafter described. The DAC 31 converts transmit signals output by the BBU 20 to the analog domain and the ADC 33 converts analog signals to the digital domain for input to the BBU 20. The RF transceiver 62 comprises a RF receiver 64 and RF transmitter 66 configured to operate according to applicable standards. The front-end circuit 68 connects the RF transceiver 62 to an antenna array comprising one or more shared antennas or antenna elements 90. FIG. 2 illustrates the connection to one antenna or antenna element 90 with the understanding that each antenna or antenna element 90 has a similar arrangement. The shared antenna or antenna element 90 is used for both transmission and reception.

In this embodiment, the front-end circuit 68 is configured for time division duplex (TDD) operation. The front-end circuit 68 comprises a transmit signal path 70 and a receive signal path 80 connecting the RF transmitter 66 and RF receiver 64 respectively to the antenna or antenna element 90 via a duplex switch 88. The duplex switch 88 is movable between a receive position to connect the antenna or antenna element 90 to the RF receiver 64 and a transmit position to connect the antenna or antenna element 90 to the RF transmitter 66. The transmit signal path 70 includes a pre-power amplifier (PPA) 72 and power amplifier (PA) 74 for amplifying communication signals output by the RF transmitter 66 in a communication mode. Switches 76 and 78 allow the BBU 20 to disable the PPA 72 and PA 74 during radar signal transmission. A radar amplifier 82 is connected between the transmit signal path 70 and receive signal path 80. The radar amplifier 82 takes the input from the transmit signal chain, e.g., before the PPA 72. The PPA 72 and PA 74 are turned off during radar operation, and the duplex switch 88 is placed in the receive position, connecting the receive signal path 80 to the antenna or antenna element 90. The small radar amplifier 82 injects the transmitted radar signal into the receive signal path 80, which is connected to the antenna 90, through a large impedance (Z) 84. The large impedance (Z) 84 provides a large voltage division between Z and the RF receiver input impedance, dividing the voltage from the small radar amplifier 82 at the RF receiver input, so that a small signal only is injected to avoid saturating the RF receiver 64. The connection of the radar signal to the receive port of the duplex switch 88 protects the radar amplifier from large voltage levels generated when communication signals are transmitted.

In a communication signal transmission mode, the PPA 72 and PA 74 are enabled and the duplex switch 88 is in the transmit position. The RF transceiver 66 outputs a communication signal, which is amplified by the PPA 72 and PA 74 and radiated by the antenna or antenna element 90. The radar amplifier 82 can be disabled in the communication signal transmit mode. In a communication signal receive mode, the PPA 72 and PA 74 are disabled and the duplex switch 88 is in a receive position so that the received signal is coupled to the RF receiver input. The radar amplifier 82 can be disabled in the communication signal receive mode if no radar signal is being transited. In a radar transmission mode, the PPA 72 and PA 74 are disabled and the duplex switch 88 is in the receive position. The RF transceiver 66 outputs a radar signal, which is amplified by the radar amplifier 82 and radiated by the antenna or antenna element 90. The BBU 20 sends a control signal to the RU 60 to enable and disable the PPA 72 and PA 74. The impedance (Z) 84 reduces the radar signal at the input of the receiver. In one embodiment, the impedance 84 is between about 500 Ohms and 5000 Ohms. In some embodiments, the impedance (Z) 84 is configured to reduce a transmitted radar signal below a signal level threshold at the RF receiver (64) input during radar signal transmission so as to enable simultaneous reception of a communication signal by the RF receiver 64. In some embodiments, the signal level threshold may be below a noise threshold at the RF receiver input. In other embodiments, the impedance (Z) 84 is configured to reduce a transmitted radar signal below a compression threshold at the RF receiver input during radar signal transmission to reduce compression at the RF receiver 64.

The −37 dBm of transmit power in the example above corresponds to just 4.5 mV voltage amplitude in a 50Ω antenna. If the radar amplifier provides 100 mV amplitude, a 1 kΩ resistor in series with the radar amplifier provides the required impedance Z to perform the voltage division. The resistor will have some internal parasitic capacitance, which will affect the predictability of the voltage transfer. Using a larger resistor and larger division ratio may thus not be practical. Another option is to use a capacitor to perform the voltage division. A capacitor with 1 kΩ impedance at 100 GHz would have the value 1.6 fF, which is easily realized.

There are a number of options to realize the radar amplifier 82. One approach uses a radar amplifier 82 with a tuned output, as integrated inductors have very small physical size at 100 GHz.

Another approach uses a self-biased CMOS inverter, naturally loaded by a capacitive load, and coupled to the antenna 90 with a capacitor. The load capacitor and coupling capacitor would then form a frequency independent current division network, such that a fixed fraction of the current output by the transconductances would go to the load. The efficiency would, however, be better with a tuned amplifier. The tuning could then also be designed to include the coupling capacitor, making it more efficient than using a coupling resistor.

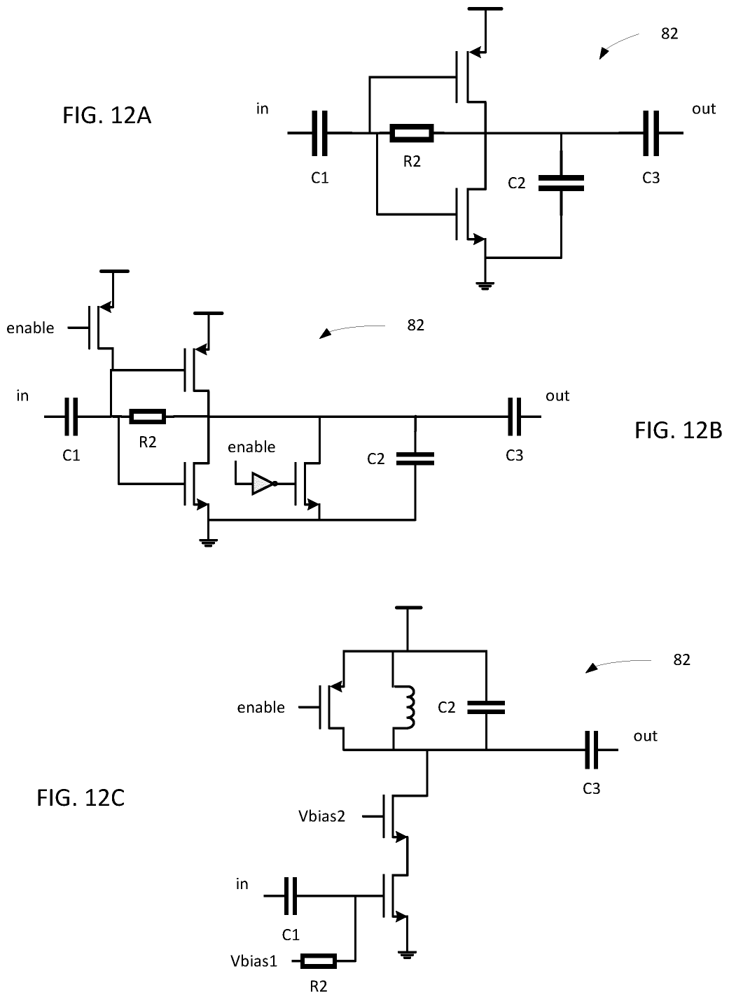

FIG. 12A illustrates a first exemplary radar amplifier 82 with a self-biased CMOS inverter. The inverter consists of the two transistors, one NMOS and one PMOS. It is self-biased by resistor R2, making the inverter input bias voltage equal to its output bias voltage. To enable this the input is AC-coupled by C1, so that the DC input voltage does not affect the inverter input bias voltage. At the output, there is a load capacitor C2, which at least partly consists of parasitic capacitances. The output is coupled to the antenna 90 (which is connected to out terminal) by coupling capacitor C3. The coupling capacitor also blocks DC at the output from affecting the bias of the inverter, similar to C1 at the input. The load capacitor C2 and coupling capacitor C3 form a frequency independent current division network, such that a fixed fraction of the current output by the transconductance of the transistors go to the antenna 90.

FIG. 12B illustrates a second exemplary radar amplifier also with a self-biased CMOS inverter. In addition to the features shown in FIG. 12, this embodiment contains protection from high voltages due to the communication PA 74. This protection is needed in the case there are separate transit and receive antennas 90a and 90B, and the radar amplifier 82 is connected to the transmit antenna 90A. In this case, the radar amplifier 82 is not protected by a duplex switch 88 during communication signal transmission. When the enable signal is low, the radar amplifier 82 is protected. The NMOS transistor at the output then conducts, since its gate voltage is made high by the inverter connected to its gate, pulling the output to ground. The inverter input is pulled high by the PMOS transistor there, with the gate connected to the enable signal. The NMOS of the inverter will then help pulling the output node towards ground. The effective resistance of the inverter output will be the parallel on-resistance of the two NMOS transistors. The resistance R2 will have close to the full supply voltage over it, by as its resistance is high the power consumption will still be low. The signal voltage at the inverter output will be the antenna voltage, reduced by the voltage division between C3 and the parallel on-resistance on the NMOS devices, and as C3 has a high impedance at the carrier frequency the signal voltage will be low, preventing damage to the transistors. When the enable signal is high, the additional transistors are off, and the amplifier works as the schematic at the top.

FIG. 12C illustrates a radar amplifier 82 configured as a tuned amplifier, where the inductor is made to resonate at the carrier frequency together with its surrounding capacitance. In this embodiment, the radar amplifier 82 comprises an NMOS cascode amplifier, where the input signal is AC connected to the gate of the bottom transistor. The gate bias voltage is set through a large resistor R2. The stacked on top transistor is a cascode device, which can be used to make the circuit more robust, improving stability and reverse-isolation. C2 is a tuning capacitor, at least partly consisting of parasitic capacitance, together with the inductor setting the center frequency of the amplifier, which is the resonance frequency of the inductor and its surrounding capacitance. C3 will also have some influence on that capacitance, but being much smaller than C2, its influence will be much less. C3 couples the signal to the antenna, being a small capacitor ensures delivering a small current. Using a capacitor for coupling also isolates the antenna from the output bias voltage of the radar amplifier 82, which is equal to the supply voltage. The protection of the radar amplifier 82, if needed, is handled by the PMOS transistor. When the enable signal is low, a low resistance is provided between the output and the supply voltage, i.e., to signal ground. Voltage division between C3 and the PMOS on-resistance then protects the transistors. When enable is high, the PMOS is off, and the radar amplifier 82 can operate and provide an output signal. The parasitics of the PMOS are included in the capacitance when designing the inductance value, so the amplifier center frequency will be correct when including the protection circuitry.

Depending on the antenna signal, the amplifiers can be single-ended or differential. In some embodiments, the radar amplifier 82 may be eliminated and the large impedance Z (or pair of impedances if differential) can be connected directly to a suitable node or node pair in the transmit signal path. The idea of reusing the communication receiver and transmitter for radar may be more problematic if the RF receiver 64 and RF transmitter 66 share parts, like phase shifters or combination networks. In this case, it becomes difficult to operate the RF receiver 64 and RF transmitter 66 simultaneously. Such transceiver architectures should thus be carefully considered when reusing communication modem parts for full duplex radar.

In embodiments of the present disclosure, beamforming along with this full-duplex radar can be used to direct the emitted radar signals and increase the sensing range. Beamforming focuses the receiver towards the sensing direction and achieves a higher quality reception of reflected signals.

The radar signal does not pose an interference problem for received communications signals in normal scenarios, due to its low power spectral density. However, the full-duplex operation may pose certain challenges for received radar signal reception because the reflected radar signal is typically attenuated by multiple 10s of dBs and requires considerable processing gain to sufficiently increase the detection SNR, even when the low noise amplifier (LNA) is not saturated.

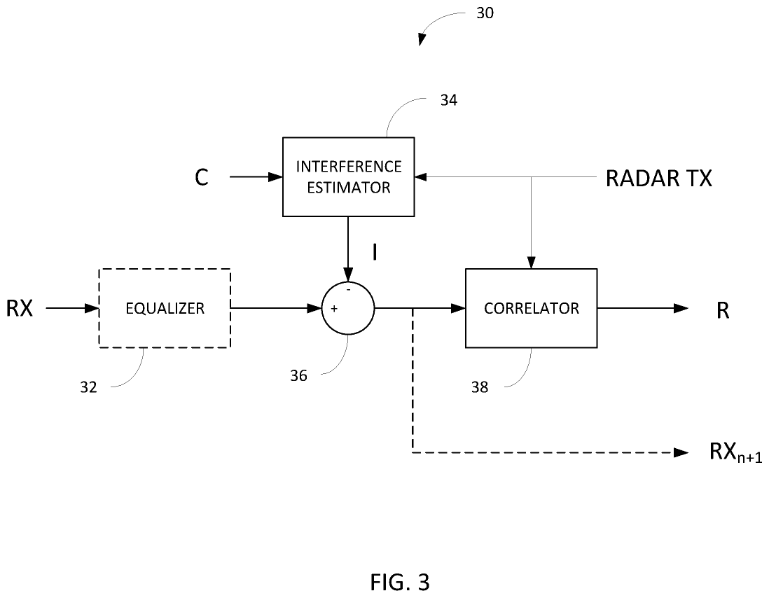

FIG. 3 illustrates one implementation of a baseband radar detector 30 for detecting reflections of the transmitted radar signal from remote objects, which is part of the radar unit 24. In this embodiment, the radar detector 30 comprises an equalizer 32, interference estimator 34, subtraction circuit 36, and correlator 38. The equalizer 32 is an optional component to compensate for the frequency response of the RF front end 68 as hereinafter described. In this example, it is assumed that the radar reflection is received without interference from a signal. The received radar signal for the reflection is input to the subtraction circuit 36 following equalization if an equalizer is present 32. A clean copy of the transmitted radar signal is input to the interference estimator 34 along with an estimate of the crosstalk channel C between the output of the RF transmitter 66 to the input of the RF receiver 64. The interference estimator 34 generates an estimate/of the interference attributable to the transmit signal leakage based on the clean radar transmit signals and the channel estimate C, and outputs the interference estimate/to the subtraction circuit 36. The subtraction circuit 36 subtracts the estimated interference from the received radar reflection to at least partially cancel the interference attributable to transmit signal leakage and outputs the reduced interference signal to the correlator 38. The correlator 38 receives the transmitted radar signal as an input and correlates the reduced interference signal with the transmitted radar signal to detect the reflected radar signal R. The correlator output R can be compared to a threshold to detect presence of a reflection.

In an alternative embodiment, leakage removal for received echo detection can be omitted if the correlation/accumulation provides a sufficient processing gain (e.g., the 20-40 dB of reflection attenuation +3-6 dB for reliable detection) and the analog-to-digital converter (ADC) and baseband processing provides sufficient computational resolution (bit widths). The processing gain example above assumes that the radar signal has a pseudo-random structure. If a special signal radar design is used that provides controlled auto-correlation properties, the required processing gain may be significantly lower. (However, such a signal design may be optimized for certain echo delays, not for arbitrary delays.)

As an additional improvement, the baseband interference cancellation circuitry may further subtract stronger echoes from the received signal to facilitate detection of further, weaker reflections. The signal to subtract may be estimated by deconvolution and filtering of the correlation response for the delay range of the echo of interest and convolving the extracted channel response with the transmitted signal.

To address radar signal leakage-induced interference to communications, the relative radar-induced interference level can be estimated based on, for example, the communication signal Reference Signal Received Quality (RSRQ) or Signal to Interference plus Noise Ratio (SINR). If that measurement is above a threshold, the communication signal can be received. Radar transmit leakage signal subtraction (interference cancellation) may also be applied as described above.

During radar detection, a received communication signal may also interfere with the received radar signal. In one embodiment, the power of received communication signal to be suppressed by the radar receiver is added as a criterion for determining the required radar processing gain. Any power measurement can be used, such as the Reference Signal Received Power (RSRP)

To take full advantage of the resolution offered by the high bandwidth, compensation for analog transfer functions may be needed. Otherwise, there is a risk that some radar accuracy is lost due to limited bandwidth in the transmitter and receiver paths as well as the antennas 90, antennas switch 88, etc.

The compensation can be performed by the digital baseband, for both transmit and receive. Digital filters, such as a Finite Impulse Response (FIR) filter, can be used to increase the level of higher baseband frequencies compared to lower ones. If a filter 35 is placed prior to the DAC 32 in the RU 60, it can compensate for subsequent drop at higher modulation frequencies due to analog bandwidth limitations. Similarly, a filter 37 placed after the ADC 34 in the receive path can lift high frequency modulation components that have been attenuated, but then also noise is raised at those frequencies. Using the filter 35 for transmission does not experience the same problem, but on the other hand, the transmit spectral density may become too high if compensating also for receive bandwidth. A good compromise is to use two filters 35, 37, one for transmission to compensate for the transmit bandwidth so that the transmitted signal has close to flat spectral density, and one for receiving to compensate for its limited bandwidth.

In case the RF channel is located off-center frequency of the RF components, such as antennas, switches, and amplifiers, the baseband frequency response will be different for positive and negative baseband frequencies. In that case a complex baseband digital filter can be used.

If incomplete or imperfect frequency compensation is applied, or none, the actual radar signal will differ to some extent from the undistorted reference copy used for receiver correlation. In one embodiment, the residual non-flat frequency response is estimated and applied to the reference sequence before performing correlation and detection.

The full duplex operation described herein enables the use of listen during talk (LDT), further improving the performance. Similar to listen before talk (LBT), the wireless communication device 10 can abort a radar transmission if it detects a strong received communication signal, after having subtracted its own transmit signal leakage, it. In this case, there is little benefit in continuing the radar transmission because the radar reception will likely be blocked by the strong communication signal when the echoes return. The wireless communication device 10 may then instead abort and save some power. Aborting also reduces risk of interfering with nearby devices when it receives, which could be either immediately if operating with full duplex or with FDD, or later if operating with TDD.

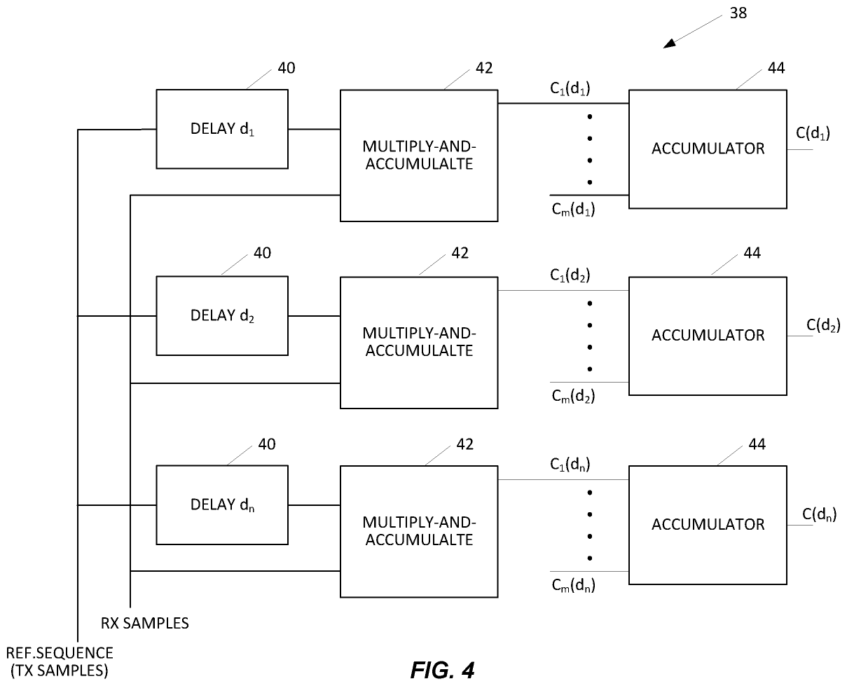

FIG. 4 illustrates an exemplary correlator 38 configured to perform discontinuous correlation as herein described. The correlator 38 implementation enables evaluation of multiple range hypotheses, i.e., target distances, in a radar application The correlator 38 comprises one or more delay units 40 followed by multiply-and accumulate (MA) circuit 42. The correlator 38 generates a partial correlation result for one of the discontinuous time periods, i.e., radar sessions. Multiple instances of the delay units 40 and MA circuits 42 can be used for different ones of the discontinuous time periods. Alternatively, the same delay circuit 40 and MA 42 can be used for different time periods and the results from each iteration can be stored temporarily. The partial correlation results for each time period is input to an accumulator (ACC) 44. There is one accumulator 44 for each delay hypothesis. The output of the accumulator 44 comprises the final correlator output.

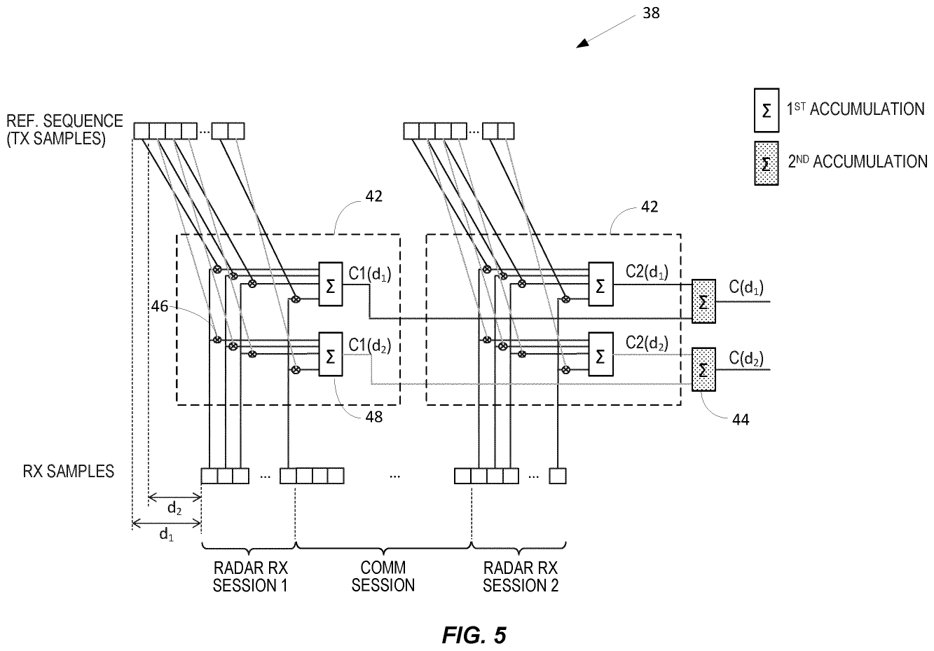

FIG. 5 illustrates a two-stage correlator 38 in more detail, where each stage produces a partial correlation result for one time period. Each stage includes a delay unit 40 for each hypothesized delay with a corresponding set of multiplication nodes 46 and accumulator 48. Radar sessions 1 and 2 are shown during which correlation and accumulation is performed. Between them is a communication session during which no radar receive sample processing is performed, e.g., to avoid interference from communication signals. In the example, the partial correlation result Ck for session k (k=1 or 2) and hypothesized delay dm (m=1 or 2) is produced as a sum of products of the received samples and correspondingly delayed reference samples. The choice of correlation type for each session, and for aggregating results from individual sessions, may be selected based on the considerations discussed below. As one example, the correlation in a given stage could be phase and amplitude, or amplitude only. The final correlation result may be coherent or non-coherent.

In a typical implementation, the correlation operation for a certain time delay (time value) constitutes a complex inner product of received samples from the radar receiver (which may share hardware with the cellular receiver) with a reference sequence of samples, delayed by the same time value. The reference sequence typically represents the transmitted radar signal. At time delays corresponding to radar signal reflections, the correlator output will have a higher magnitude, while in the absence of reflections, the correlator output is a noise-only process. The magnitude of the correlator output can be compared to a threshold to determine whether a radar reflection is present for the hypothesized delay. In fully coherent and non-impaired accumulation, the number of samples in the reference signal that are accumulated yields the processing gain, i.e., the SNR increase factor for the correlator output compared to individual input samples. If the processing gain is sufficiently large, the received radar SNR may be increased so as to bring it above the noise floor, even if it, in the received signal samples, lies tens of dBs below the noise floor.

In one receiver architecture, for each delay unit 40, there is an accumulator 48 to which is added the result of the complex multiplication of the received signal and the complex conjugate of the transmitted and correspondingly delayed signal. After the correlation time has ended, the correlation results are read out and the accumulators 48 are reset. A very long accumulation, i.e., many milliseconds, may be needed for far away echoes. For this case, the correlation results for the nearby (short) delays, corresponding to delay units 40 with short delay, can be read out more frequently and reset. Since they result in a stronger backscattered signal, a reliable result will be available more quickly, allowing faster reactions to nearby events.

In one embodiment, instead of resetting the correlation results of the individual delay units 40, a forgetting filter (e.g., 1st order infinite impulse response (IIR) filter) may be applied to gradually reduce the impact of earlier received samples, where the forgetting rate can depend on the hypothesized delay of the bin. Different forgetting factors may be applied to different delays, e.g., faster decay of memory at shorter distances.

In another receiver architecture, the correlating receiver may perform a full convolution operation with the full reference sequence, where the output of the operation indicates one or more correlation peaks, corresponding to object reflections at different distances.

The correlator approach may be referred to by multiple terms: coherent or complex correlation, matched filtering, sliding correlator, sliding matched filter (MF), MF receiver/detector, etc. All these approaches share certain digital filtering or signal convolution aspects, but their technical implementations differ. A broad class of such implementations can be utilized.

The correlation-based detection is typically performed repeatedly for different radar beam directions to achieve spatial/angular resolution in sensing. Spatial directivity may be applied at the transmit, the receive side, or both. The correlation peak detection (and possibly resulting object presence and distance identification) is then applied to each spatial direction. The set of per-direction results can then be jointly processed and aggregated for spatial imaging or other applications.

Radar correlation for radar sessions interspersed with communication sessions requires some consideration. As described above, it is also possible for the radar with long signal duration to co-operate with cellular communication in the integrated device, or other communication signals (e.g., to/from other devices) in the network. When there is a need to transmit a communication signal, so that the receiver must be disconnected from the radar processing, the radar unit 24 can temporarily pause the correlating. Then, as the communication transmission ends, the radar transmission and reception can continue and the accumulation of the correlation can continue from the point where is stopped, as long as the total reception time including the discontinued reception gaps is still within the mobility-dependent correlation time (discussed below). Alternatively, multiple shorter correlations can be summed up non-coherently if the allowed correlation time otherwise would be exceeded.

One aspect of the discontinuous coherent correlation is that the phase of the received signal must remain consistent with respect to the reference signal in the correlator 38. Since the transmitter 66 and the receiver 64 for radar transmission are typically driven by the same local oscillator (LO), and the LO itself need not be modified between the radar and communication modes, the potential phase changes are caused by RF front end circuitry 68; primarily frequency drift in the frequency reference, e.g., crystal oscillator. The radar mode can utilize the communication mode frequency tuning, but it would also be possible to change the frequency, if needed—the phase locked loop (PLL) can be designed to settle in less than 10 us, which is very fast compared to the long correlation times contemplated for radar. As an example, a 10 m distance to an object, i.e., 20 m roundtrip, corresponds to 6700 wavelengths at 100 GHz. A phase shift of 20 degrees in the received signal, at which coherent correlation efficiency starts to decrease (although not significantly), requires the frequency to shift by 1/(6700*(360/20))=8.3 ppm. This large drift in crystal frequency does typically not occur over ˜10 ms, so maintaining phase stability in typical scenarios is feasible.

In some implementations, if the RF configuration is changed when switching between radar and communication modes, the changes may cause phase transients in analog circuitry. In one embodiment, the RF hardware is designed so that such phase transients are “reciprocal”, i.e., equal and opposite when switching to and from the communications mode, and the effective signal phase when returning to the radar mode has changed less than a threshold. In another embodiment, the phase transient in each direction is estimated and the aggregate is compensated. In a related embodiment, instead of estimating the transients in live operation, the transients may be estimated at design time for different switching scenarios and conditions (carrier frequency, bandwidth, temperature, etc.) and tabulated.

In one embodiment, the radar reception processing is performed in the same hardware as the communication processing. Pausing radar processing then amounts to switching processing software in the device, including baseband algorithms and optionally reconfiguring RF front end (RF bandwidth and target performance metrics, analog-to-digital (ADC) resolution, etc.). The receiver state, including frequency/time reference and correlator status, are stored for later retrieval to resume the correlation.

In another embodiment, radar processing may be performed in a separate hardware unit. Antennas are then switched from the radar unit to the cellular unit using antenna switches. The radar unit's frequency reference is preferably kept synchronized with the cellular receiver LO to maintain tight phase consistency. In one embodiment, different clock trees and clock generation may be implemented in the cellular and radar units, providing the advantage of higher isolation in-between the two and thereby less risk of phase shifts due to radar/cellular mode switching. They can maintain coarse timing synchronization for radar discontinuity handling (mode switching over communication session gaps), but not necessarily at RF phase accuracy level.

In one embodiment, the wireless communication device 10 may also pause radar signal transmission for time intervals where the receiver is not available for radar signal collection, e.g., due to communication signal transmission.

In one embodiment, the wireless communication device 10 may also pause radar transmission when the radar transmitter is not available for radar signal transmission due, for example, to transmission of communications signals, possibly in other beam directions, or while the communication signal power level is excessively large compared to the radar signal power level and the transmitter dynamic range does not allow transmitting both signal components with a sufficient fidelity.

In one embodiment, discontinuous radar operation means that radar processing is not performed during the communication session, but the backscattered radar signal may still be received. In this case, the discontinuous processing entails recording radar receive signals so that the correlation over the entire time period, including the communication session, can be performed later.

In case the wireless communication device 10 has multiple antenna panels, and/or the radar and communication directions are spatially well separated, the communication may be switched to panels or beams currently not used for radar, to prolong the radar correlation time without pausing the correlation process. The radar user equipment (UE) may also select the panel best aligned to the target to pick up the reflections to avoid discontinuity in the correlation.

In one embodiment, particularly suitable for low communication signal levels, the radar reception process is not interrupted when communication signals are present, but their power and duration are estimated, the required radar signal processing gain is updated and the correlation length extended accordingly.

In one group of embodiments, discontinuous radar signal correlation may be applied based on the device's own communication activity. The discontinuous correlation pattern is determined so as to obtain sufficient processing gain and the last radar reflection in accordance with the schedule avoids communication signal-induced interference to radar detection.

The radar unit 24 can obtain communication scheduling information and other communications-related transceiver activity information from the communication unit 22. The schedule and activity info may be pre-scheduled, e.g., according to planned measurements, paging, or data control channel monitoring occasions. It may also be immediately triggered, e.g., UL data appearing in application buffers. Depending on the device implementation, the information is provided as a software message referring to a common timing reference in the single transceiver architecture (if radar processing is performed in same hardware as cellular operation) or via an external interface to the radar unit (if radar processing is performed in a separate hardware unit).

In another group of embodiments, the wireless communication device 10 may also interrupt or adapt radar correlation when other, interfering communication signals are present in the network, downlink (DL) or uplink (UL). Interference to radar detection, induced by such signals, can thus be avoided or mitigated.

The radar-enabled wireless communication device 10 may obtain information about such other transmissions, for example, by detecting the presence of such signals using its communication receiver (e.g., in architectures where the radar and communication transceivers can be active simultaneously), or by detecting changes in correlation quality reception (e.g., by observing short-term changes correlation output, suggesting insertion of a significantly stronger, above-noise signal). Alternatively, the information about ongoing or scheduled transmissions, e.g., their time-frequency location and power, may be provided as control information from a base station or from other wireless communication devices 10 in the vicinity via sidelink.

In one embodiment, the radar receiver in the radar unit 24 will pause correlation pre-emptively or as soon as other communication signal is detected. The radar receiver may also estimate the duration of time that the other signal has entered the receiver, and its power, and correspondingly adjust the target processing gain and the corresponding correlation length.

In some embodiments, the target objects in the environment may be moving relative to the wireless communication device 10. The maximum movement speed of an object before the phase of the reflected is shifted by 180 degrees for a 100 GHz radar carrier is λ/(4*integration time)=0.003/(4*0.003)=0.25 m/s=0.9 km/h for a 3 ms integration time. This is a bit slow to capture moving objects indoor. By skipping the phase information and correlating just for magnitude, targets moving by up to 9 km/h towards or away from the radar (radial movement speed) can be handled. The 10× improvement is due to the modulation bandwidth being ˜10× lower than the carrier frequency in this case. Some SNR is, however, lost in discarding the phase information, increasing the minimum detectable radar cross section. Denoting the accumulation time as T_{c}, for magnitude-only accumulation, the detection SNR increases as proportional to \sqrt{T_{c}}, as opposed to proportional to T_{c} for coherent accumulation.

In one approach, the total detection time T_{c} may be divided into N coherent blocks whose outputs are combined non-coherently. The processing gain is then ˜T_{c}/\sqrt{N}, instead of ˜T_{c} for fully coherent detection.

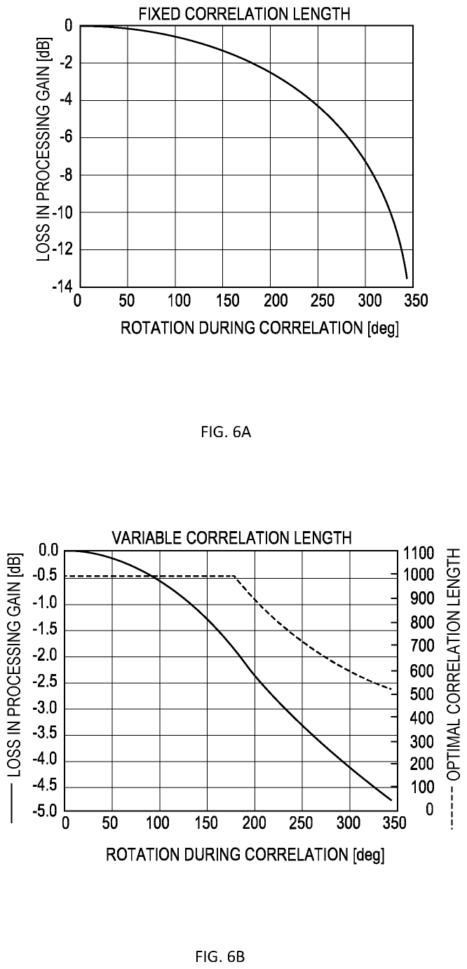

The loss of processing gain versus receive signal phase rotation during correlation is shown in FIG. 6A, for a single correlation with a reference signal without phase rotation. The loss is about 2 dB for a 180 degree rotation during the correlation interval, and then the loss increases rapidly with more rotation, and at 360 degrees all signal is lost. In the FIG. 6B, the correlation is instead divided into coherent intervals that are accumulated non-coherently, where the division is optimized for minimum loss. The loss can be reduced for rotations above 180 degrees, the improvement increasing with amount of rotation. In the different coherent/non-coherent interval comparisons, the total number of samples used for correlation is equal in all compared cases.

In one embodiment, the processing gain trade-offs can be used to determine the Doppler threshold for switching between phase-coherent and amplitude-only processing. In one embodiment, powers from groups of coherently accumulated samples can in turn be accumulated non-coherently.

In one embodiment, permitted correlation length is estimated based on above considerations, using estimated movement speed, carrier frequency, etc., parameters. In another embodiment, proper correlation length may be found by comparing multiple short measurements accumulated vs. one long measurement. If the long measurement result is weaker, then the coherent correlation time is too long for the phase rotation rate.

The depth resolution would be on the order of speed of light divided by the bandwidth, which is centimeters in this case. Because the phase information is used in the correlation, it is possible to detect when object moves by a fraction of an RF wavelength, which means fractions of millimeters, even below 100 um. The radar could then be used to track e.g., vital signs.

The correlation configuration can be adapted for different use case scenarios. For scenarios where the radar processing may be interrupted/paused due to transmission or reception of communication signals and correlation times may extend to multiple milliseconds, the correlation mode can be optimized to achieve minimum reception length for the scenario at hand. The long-term correlation considerations explored above, combined with other criteria, can be used to determine a suitable radar correlation configuration.

Scenario characteristics that may be considered for correlation optimization may include the following:
Radar measurement schedule: duration of available measurement segments, duration and rate of communication-induced gaps in measurements, measurement period, required update rate, . . .
Required processing gain: depending on object distance, object radar cross-section, signal power, noise plus interference level . . .
Coherence limits: radial movement of the object, radar signal frequency, LO accuracy, radar signal bandwidth . . .

The following aspects may be part of radar reception configuration:
Correlation length/duration
Coherent accumulation vs. non-coherent accumulation of coherent blocks, incl. block duration
Phase-coherent or amplitude-only correlation, radar signal type selection

Some examples of criteria and corresponding choices of configuration aspects are listed below. Aspects left blank or not mentioned for a given criterion have lower priority and may be selected to meet other criteria.

| | | |
|---|---|---|
| | Coherent | |
| Correlation | block | Phase or |
| length | length | amplitude |

Radar measurement schedule constraints

| | | | |
|---|---|---|---|
| Frequent radar updates | Shorter | | Phase |
| Infrequent radar updates | Longer | | Amplitude |
| Short comm sessions | | Longer | |
| Long comm sessions | | Shorter | |
| Frequent comm | | Shorter | |
| sessions (short radar | | | |
| segments) | | | |
| Infrequent comm | | Longer | |
| sessions (long radar | | | |
| segments) | | | |

Required processing gain

| | | | |
|---|---|---|---|
| Higher: far object, | Longer | Longer (or | Phase |
| smaller x-section, lower | | fully | |
| TX power, high N + I | | coherent) | |
| Lower: near object, | Shorter | Shorter | Amplitude |
| larger x-section, higher | | | |
| TX power, lower N + I | | | |

Coherence time

| | | |
|---|---|---|
| Shorter: faster radial | Shorter | Amplitude |
| movement, higher radar | | |
| frequency, lower LO | | |
| accuracy, higher BW | | |
| Longer: slow radial | Longer (or | Phase |
| movement, low radar | fully | |
| frequency, high LO | coherent) | |
| accuracy, lower BW | | |

Configuration choices for the listed aspects where multiple criteria point in different directions are determined implementation-specifically. In typical embodiments, the radar measurement schedule may be given higher priority. Additional examples of trade-offs may include:
Trade off bandwidth and max speed: a reduced bandwidth could be used to increase the max speed at expense of range resolution.
Shorter coherent block length may be required due to being interrupted by long communication sessions and coherence cannot be not assumed after interruption if the breaks are too long to maintain the coherence.
If the updates are frequent then each measurement may need to be shorter, thus it needs to be more efficient (phase etc.), and the reverse-if there is more time per measurement, we can allow longer time per measurements (and perhaps handle larger drifts, etc.

In one embodiment, the bandwidth parameter may be configurable. For example, using smaller bandwidth (especially for amplitude modulation) could allow a larger max speed at expense of time resolution.

For given carrier frequency and bandwidth, the table may be used following the procedure (example):
A determination step of category above:
   Radar characteristics like frequency, bandwidth (and bandwidth scaling), implementation dependent parameters like phase stability etc.
   Object characteristics like expected range to object, object radar size, speed of object etc.
   Service dependent characteristics like detectability criticality (including risk of false alarms), required range resolution, speed range etc.
Determine required radar periodicity based on these characteristics
Determine communication gaps available for radar
Determine dependent category and gaps apply modulation scheme and correlation time/correlation split up

Some parameter combinations in typical scenarios for example, may be objects close with small speed, objects far away with high speed etc., detecting closer objects with faster update rate (requiring shorter measurements), etc.

By adaptively invoking the phase-coherent correlation for nearby echoes with shorter correlation interval, fine movements within a fraction of an RF wavelength, i.e. fractions of a millimeter can be detected. The target velocities and ranges for such a radar system will, if designed properly, be adequate for indoor use.

For nearby objects, it may be more important to monitor those more frequently, and a shorter correlation time can be used. For more distant objects, a longer correlation time would be needed but it may be less important to monitor them as frequently. Hence, the sensing duty cycle that can be adjusted based on previously estimated object distance.

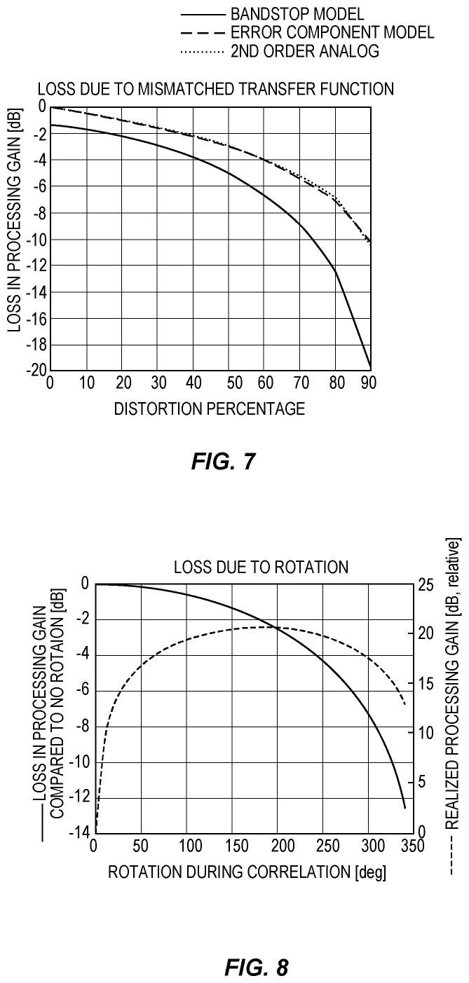

In some scenarios, the small signal radar path may not have a flat frequency response and the correlation may be slightly mismatched. Even without any frequency compensation, the loss in correlation gain is still manageable. The simulation shown in FIG. 7 demonstrates the sensitivity to errors in the frequency response:

In the simulations, three modeling cases were considered:
1. The actual transfer function was same shape but X % narrower than assumed bandwidth (essentially removing X % of the signal energy)
2. The transfer function response was X % “off” (i.e. same BW and same total energy transferred, but with a “response error” component added that is X % of the total response power)
3. The actual transfer function had a 2nd order analog filter characteristic, while flat response was assumed in correlation, and 3 dB roll-off was X % narrower than the assumed BW.

The results show the behavior of processing gain G obtained from coherent accumulation of some number of samples N. With a perfect match to the reference sequence (incl. transfer function response), G=N, but with a mismatch, G<N, so the loss can be interpreted as is G/N. The first two modeling cases show roughly similar losses, close to proportional to the distortion percentage as expected, indicating that there are no hidden complications. Since the analog filter variant removes some energy due to roll-off even at correct assumed bandwidth, its curve lies 1.6-2 dB lower.

The qualitative behavior is quite benign for non-extreme mismatch and the mismatch can be “fixed” by scaling up the correlation time correspondingly, which may make it necessary to break accumulation into multiple shorter coherent blocks for some use scenarios where we need to push the processing gain but the concept remains viable.

The original curves showing processing gain loss due to rotation remain applicable and can, together with the mismatch loss, be used to determine the maximum coherent correlation time in the presence of a frequency offset and a partially unknown transfer function.

For example: if we need processing gain of 20 dB, the frequency offset/drift is 25 Hz, we can get 15 k samples/s, and we may have a transfer function mismatch of 30%. Then we see from the first plot that, for mismatch consisting of unaccounted for 2nd order roll-off and 10% narrower actual 3-dB BW than assumed, we need to aim at approximately 1.6 dB higher processing gain, i.e. ˜1.4 times more samples, or N=140. That takes 9.3 ms to collect during which the rotation is 83 deg. Referring to FIG. 8, the loss due to rotation 83 deg is 0.4 dB and the realized processing gain needs to be extended by that amount, i.e. from relative 18.9 to relative 19.3 dB. We thus extend the correlation time by further 11% (inferred from rotation values 83 and 93 deg, corresponding to 18.9 and 19.3 dB, respectively), total correlation over 10.4 ms for 155 samples, instead of nominal 6.7 ms for 100 samples. If operating in the left part where the realized gain curve continues growing, there may be a solution for single coherent correlation block, like in this example. If no sufficient realized gain increase is available or we are on the part with negative first derivative, we instead break the accumulation into multiple shorter blocks and combine block-wise magnitudes. The correlation approach is thus relatively robust to incomplete transfer function knowledge and frequency offsets.

The radar sequence, used as a reference sequence in the correlator 38, preferably has a pseudo-random structure so that arbitrary misalignment results in low cross-correlation, to robustly reduce the detection noise floor. The low cross-correlation should be maintained when partial sequences are correlated at arbitrary offsets/delays. Some examples of such sequences include real or complex m-sequences, real or complex Gold sequences, etc.

When the radar receiver receives in the magnitude correlation mode, e.g., when phase information is not available, or phase coherence cannot be ensured. the radar signal should contain amplitude variations. As sequence components in the real and/or I/Q dimensions, multi-level signals may be used to allow amplitude-only (envelope) correlation, e.g., on-off, 4-PAM or 16-QAM may be used; the latter provides improved performance when also phase-coherent correlation is possible.

When phase-coherent correlation at the symbol level is configured, the radar signal may have a constant modulus (amplitude) nature (e.g., frequency shift keying (FSK), phase-shift keying (PSK), etc.).

Advantages of the full-duplex, below-noise radar operation as herein described include:
Minimum of RF resources used by radar.
Minimum impact on RF resources for communication.
Radar transit leakage without significant attenuation can be allowed to enter the receiver, dramatically simplifying the transceiver design.
Using wide-band operation, signal spectral density can be kept low even for high output power, also increasing the depth resolution.
The extremely low power spectral density even in the transmission beam direction makes the probability of disturbing communication very low.

The correlation optimization aspects of the invention in the above radar context provide following advantages:
Radar operation requires no scheduling or resource coordination with communication and allows the full duplex radar to operate in scenarios where extended gaps (multiple ms) are not available between communication occasions. Coordination is only terms of local receiver resources in the receiver.
Coherent correlation can be maintained across communication sessions, maximizing processing gain and detection speed
Correlation mode can be selected that maximizes processing efficiency based on signal quality, device mobility and frequency stability, etc.
Radar sensitivity and responsiveness is thus improved.

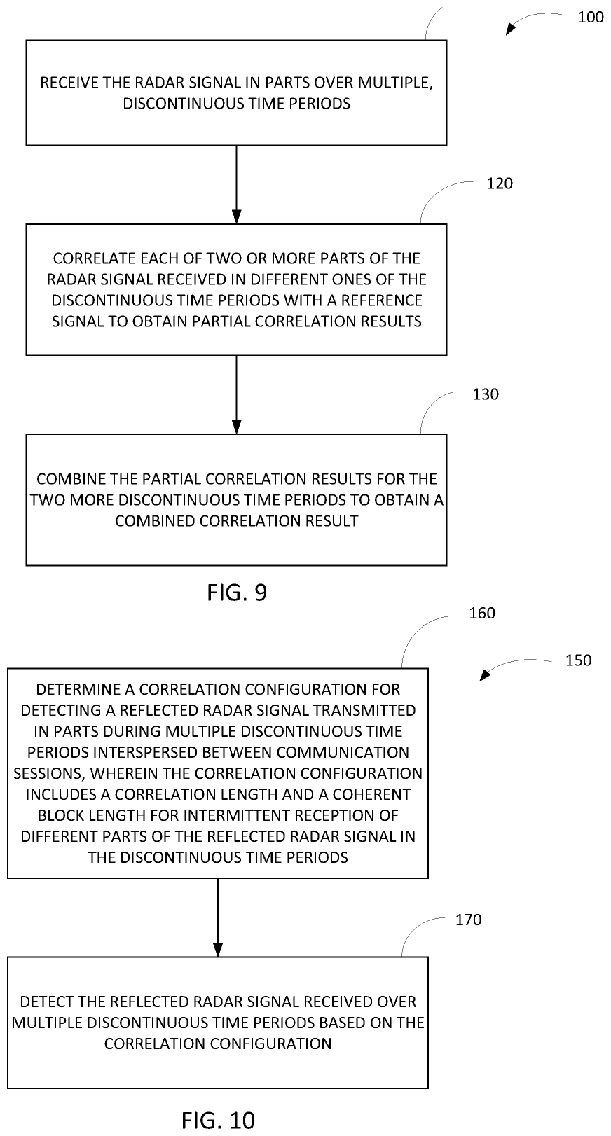

FIG. 9 illustrates a method 100 implemented by a wireless communication device 10 of detecting a low power radar signal transmitted in parts. The wireless communication device 10 receives the radar signal in parts over multiple, discontinuous time periods (block 110). The wireless communication device 10 correlates each of two or more parts of the radar signal received in different ones of the discontinuous time periods with a reference signal to obtain partial correlation results (block 120). The wireless communication device 10 further combines the partial correlation results for the multiple time periods to obtain a combined correlation result (block 130).

Some embodiments of the method 100 further comprise transmitting the parts of the radar signal between communication occasions.

In some embodiments of the method 100, transmitting the radar signal in parts between communication occasions comprises interrupting radar transmission for each of one or more communication occasions and resuming radar transmission following the communication occasion.

In some embodiments of the method 100, at least one of the discontinuous time periods overlaps a communication session.

In some embodiments of the method 100, receiving the radar signal in parts over multiple, discontinuous time periods comprises maintaining phase coherence across two or more of the discontinuous time periods.

In some embodiments of the method 100, correlating each of two or more parts of the radar signal received in different ones of the discontinuous time periods with a reference signal to obtain partial correlation results comprises phase-coherent correlation.

In some embodiments of the method 100, correlating each of two or more parts of the radar signal received in different ones of the discontinuous time periods with a reference signal to obtain partial correlation results comprises amplitude-only correlation.

In some embodiments of the method 100, correlating each of two or more parts of the radar signal comprises, for each time period, multiplying samples of the radar signal received in the time period with corresponding reference samples in the reference signal according to a time delay hypothesis for a certain target distance and accumulating products of the multiplications to obtain the partial correlation result for the time period.

In some embodiments of the method 100, combining the partial correlation results for the two or more discontinuous time periods to obtain a combined correlation result comprises summing the partial correlation results coherently for the two or more discontinuous time periods.

In some embodiments of the method 100, combining the partial correlation results for the two more discontinuous time periods to obtain a combined correlation result comprises summing the partial correlation results non-coherently for the two or more discontinuous time periods.

In some embodiments of the method 100, correlating the correlating is performed according to a correlation configuration including a correlation length and a coherent block size.

Some embodiments of the method 100 further comprise adjusting the correlation configuration based on at least one of signal rotation of the radar signal and frequency transfer function of the radar signal path.

FIG. 10 illustrates a method 150 implemented by a wireless communication device of detecting a low power radar signal transmitted in parts. The wireless communication device 10 determines a correlation configuration for detecting a reflected radar signal transmitted in parts during multiple discontinuous time periods interspersed between communication sessions (block 160). The correlation configuration includes a correlation length and a coherent block length for intermittent reception of different parts of the reflected radar signal in the discontinuous time periods. The wireless communication device 10 detects the reflected radar signal received over multiple discontinuous time periods based on the correlation configuration (block 170).

In some embodiments of the method 150, the correlation configuration further comprises a correlation mode.

In some embodiments of the method 150, the correlation mode comprises a first configuration parameter indicating whether correlation within one of the discontinuous time periods of samples of the reflected radar signal with samples of a reference comprises phase-coherent correlation or amplitude-only correlation.

In some embodiments of the method 150, the correlation mode comprises a second configuration parameter indicating whether partial correlation results for different time periods are accumulated coherently or non-coherently.

In some embodiments of the method 150, the correlation configuration is determined based at least in part on a desired processing gain.

In some embodiments of the method 150, the desired processing gain is determined based on one or more of target object characteristics, target object distance, mobility, and expected signal strength of the reflected radar signal.

In some embodiments of the method 150, the correlation configuration is determined based at least in part on scheduling constraints.

In some embodiments of the method 150, the coherent block length is determined based at least in part on a transmission pattern associated with communication sessions.

In some embodiments of the method 150, the correlation length is determined based at least in part on a desired frequency of radar measurement updates.

In some embodiments of the method 150, the correlation configuration is determined based at least in part on a coherence time.

In some embodiments of the method 150, the coherence time is determined based on one or more of a radar frequency, a local oscillator accuracy, mobility, and target distance.

In some embodiments of the method 150, at least one of the coherent block length and correlation mode are determined based on the coherence time.

In some embodiments of the method 150, determining the correlation configuration is further based on at least one of signal rotation of the radar signal and frequency transfer function of the radar signal path.

In some embodiments of the method 150, detecting the reflected radar signal received over multiple discontinuous time periods based on the correlation configuration comprises receiving the radar signal in parts over multiple, discontinuous time periods, correlating, based on the correlation configuration, each of two or more parts of the radar signal received in different ones of the discontinuous time periods with a reference signal to obtain partial correlation results, and combining the partial correlation results for the two more discontinuous time periods to obtain a combined correlation result.

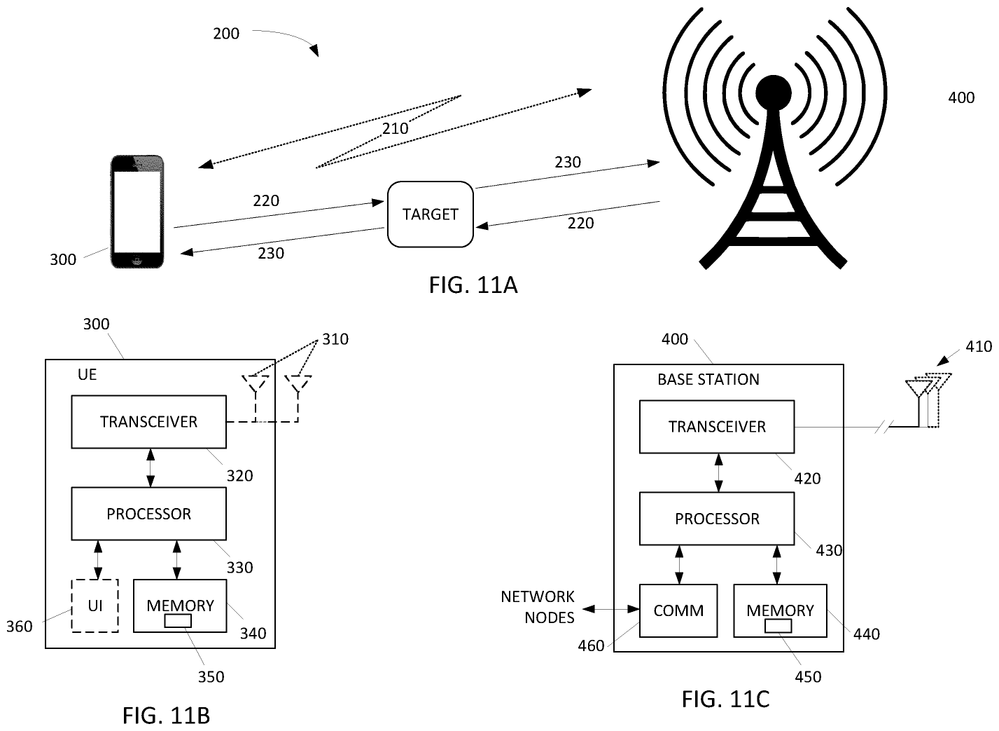

FIG. 11A illustrates an exemplary wireless communication network 200 including one or more wireless communication devices with radar capability. A user equipment (UE) 300, and base station 400 communicate over a wireless communication channel 210 according to any applicable standard, such as 5G or 6G. In some embodiments, the UE 300 and base station 400 may operate in the millimeter wave frequency bands. The UE 300 and/or base station 400 may also be configured to transmit low power spectral density radar signals in the same frequency bands used for communications and to receive reflected radar signals from objects in the surrounding environment.

FIG. 11B illustrates a user equipment (UE) 300 with radar capability according to an embodiment. As used herein, the term UE may refer to a user-operated telephony terminal, a machine-to-machine (M2M) device, a machine-type communications (MTC) device, a Narrowband Internet of Things (NB-IoT) device (in particular a UE implementing the 3GPP standard for NB-IoT), etc. A UE 300 may also be referred to as a radio device, a radio communication device, a wireless communication device, a wireless terminal, or simply a terminal—unless the context indicates otherwise, the use of any of these terms is intended to include device-to-device UEs or devices, machine-type devices or devices capable of machine-to-machine communication, sensors equipped with a radio network device, wireless-enabled table computers, mobile terminals, smartphones, laptop-embedded equipped (LEE), laptop-mounted equipment (LME), USB dongles, wireless customer-premises equipment (CPE), and the like.

The UE 300 transmits and receives RF signals, which may for example be in the millimeter wave frequency bands, on at least one antenna 310, which may be internal or external, as indicated by dashed lines. The RF signals are generated and received by a transceiver circuit 320. The transceiver circuit is configured to transmit and receive both communication signals and low power spectral density radar signals was previously described. Transceiver circuit 320, as well as other components of the UE 300, are controlled by processing circuitry 330. Memory 340 operatively connected to the processing circuitry 330 stores software in the form of computer instructions operative to cause the processing circuitry 320 to execute various procedures. An optional user interface 360 may include output devices such as a display and speakers (and/or a wired or wireless connection to audio devices such as ear buds), and/or input devices such as buttons, a keypad, a touchscreen, and the like. As indicated by the dashed lines, the user interface 360 may not be present in all UEs 300; for example, UEs 300 designed for Machine Type Communications (MTC) such as Internet of Things (IoT) devices, may perform dedicated functions such as sensing/measuring, monitoring, meter reading, and the like, and may not have any user interface 13608 features.

FIG. 11C illustrates a base station with radar capability according to an embodiment. The base station 400—known in various network implementations as a Radio Base Station (RBS), Base Transceiver Station (BTS), Node B (NB), enhanced Node B (eNB), Next Generation Node B (gNB), or the like—is a node of a wireless communication network that implements a Radio Access Network (RAN) in a defined geographic area called a cell, by providing radio transceivers to communicate wirelessly with a plurality of UEs 300.

The base station 400 transmits and receives RF signals (including MIMO signals), which may for example be in the millimeter wave frequency bands, on a plurality of antennas 410. As indicated by the broken line, the antennas 410 may be located remotely from the base station 400, such as on a tower or building. The RF signals are generated and received by a transceiver circuit 420. The transceiver circuit 420, as well as other components of the base station 400, are controlled by processing circuitry 430. Memory 440 operatively connected to the processing circuitry 430 stores instructions operative to cause the processing circuitry 430 to execute various procedures. Although the memory 440 is depicted as being separate from the processing circuitry 430, those of skill in the art understand that the processing circuitry 430 includes internal memory, such as a cache memory or register file. Those of skill in the art additionally understand that virtualization techniques allow some functions nominally executed by the processing circuitry 430 to actually be executed by other hardware, perhaps remotely located (e.g., at a data center in the so-called “cloud”). Communication circuitry 460 provides one or more communication links to one or more other network nodes, propagating communications to and from UEs 300, from and to other network nodes or other networks, such as telephony networks or the Internet.

Processing circuitry 330, 430 may comprise any sequential state machine operative to execute machine instructions stored as machine-readable computer programs in memory 16, 26, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

Memory 340, 440 may comprise any non-transitory machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like.

The transceiver circuits 320, 420 are operative to communicate with one or more other transceivers via a Radio Access Network (RAN) according to one or more communication protocols known in the art or that may be developed, such as IEEE 802.xx, CDMA, WCDMA, GSM, LTE, UTRAN, WiMax, NB-IoT, or the like. The transceiver circuits 320, 420 implement transmitter and receiver functionality appropriate to the RAN links (e.g., frequency allocations and the like). The transmitter and receiver functions may share circuit components and/or software, or alternatively may be implemented separately.

The communication circuitry 460 may comprise a receiver and transmitter interface used to communicate with one or more other nodes over a communication network according to one or more communication protocols known in the art or that may be developed, such as Ethernet, TCP/IP, SONET, ATM, IMS, SIP, or the like. The communication circuits 28 implement receiver and transmitter functionality appropriate to the communication network links (e.g., optical, electrical, and the like). The transmitter and receiver functions may share circuit components and/or software, or alternatively may be implemented separately.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

1-40. (canceled)

41. A method implemented in a wireless communication device of detecting a radar signal, the method comprising:
receiving the radar signal in parts over multiple, discontinuous time periods;
correlating each of two or more parts of the radar signal received in different ones of the discontinuous time periods with a reference signal to obtain partial correlation results; and
combining the partial correlation results for the two more discontinuous time periods to obtain a combined correlation result.

42. The method of claim 41, further comprising transmitting the parts of the radar signal between communication occasions.

43. The method of claim 42, wherein transmitting the radar signal in parts between communication occasions comprises interrupting radar transmission for each of one or more communication occasions and resuming radar transmission following the communication occasion.

44. The method of claim 41, where at least one of the discontinuous time periods overlaps a communication session.

45. The method of claim 41, wherein receiving the radar signal in parts over multiple, discontinuous time periods comprises maintaining phase coherence across two or more of the discontinuous time periods.

46. The method of claim 41 wherein correlating each of two or more parts of the radar signal received in different ones of the discontinuous time periods with a reference signal to obtain partial correlation results comprises phase-coherent correlation or amplitude only correlation.

47. The method of claim 46, wherein correlating each of two or more parts of the radar signal comprises, for each time period, multiplying samples of the radar signal received in the time period with corresponding reference samples in the reference signal according to a time delay hypothesis for a certain target distance and accumulating products of the multiplications to obtain the partial correlation result for the time period.

48. The method of claim 41, wherein combining the partial correlation results for the two or more discontinuous time periods to obtain a combined correlation result comprises summing the partial correlation results coherently or non-coherently for the two or more discontinuous time periods.

49. The method of claim of claim 41, wherein the correlating the correlating is performed according to a correlation configuration including a correlation length and a coherent block size.

50. The method of claim 49, further comprising adjusting the correlation configuration based on at least one of signal rotation of the radar signal and frequency transfer function of the radar signal path.

51. A wireless communication device with radar capability, the communication device comprising:
communication circuitry configured for below noise, full-duplex radar; and
processing circuitry configured to detect a reflected radar signa, the processing circuitry being configured to:
receive the radar signal in parts over multiple, discontinuous time periods;
correlate each of two or more parts of the radar signal received in different ones of the discontinuous time periods with a reference signal to obtain partial correlation results; and
combine the partial correlation results for the two more discontinuous time periods to obtain a combined correlation result.

52. The wireless communication device of claim 51, further comprising transmitting the parts of the radar signal between communication occasions.

53. The wireless communication device of claim 52, wherein transmitting the radar signal in parts between communication occasions comprises interrupting radar transmission for each of one or more communication occasions and resuming radar transmission following the communication occasion.

54. The wireless communication device of claim 51, where at least one of the discontinuous time periods overlaps a communication session.

55. The wireless communication device of claim 51, wherein receiving the radar signal in parts over multiple, discontinuous time periods comprises maintaining phase coherence across two or more of the discontinuous time periods.

56. The wireless communication device of claim 51 wherein correlating each of two or more parts of the radar signal received in different ones of the discontinuous time periods with a reference signal to obtain partial correlation results comprises phase-coherent correlation or amplitude only correlation.

57. The wireless communication device of claim 56, wherein correlating each of two or more parts of the radar signal comprises, for each time period, multiplying samples of the radar signal received in the time period with corresponding reference samples in the reference signal according to a time delay hypothesis for a certain target distance and accumulating products of the multiplications to obtain the partial correlation result for the time period.

58. The wireless communication device of claim 51, wherein combining the partial correlation results for the two or more discontinuous time periods to obtain a combined correlation result comprises summing the partial correlation results coherently or non-coherently for the two or more discontinuous time periods.

59. The wireless communication device of claim 51, wherein the correlating the correlating is performed according to a correlation configuration including a correlation length and a coherent block size.

60. The wireless communication device of claim 59, further comprising adjusting the correlation configuration based on at least one of signal rotation of the radar signal and frequency transfer function of the radar signal path.
